(19) United States
(12) Patent Application Publication
(10) Pub. No.: US 2006/0143064 A1
(43) Pub. Date: Jun. 29, 2006

(54) Method and system for managing events

(76) Inventors: Von A. Mock, Boynton Beach, FL (US); Juan C. Fernandez, Boca Raton, FL (US); Jorge L. Perdomo, Boca Raton, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/022,095

(22) Filed: Dec. 23, 2004

(51) Int. Cl. G06F 9/46

(52) U.S. Cl. 705/9

(57) ABSTRACT

The invention concerns a method (300, 500) and system (100) for managing an event. The method can include the steps of assigning (312) a number of participants (410) to participate in an event, selectively monitoring (314) the participants beginning at a predetermined time and based on the monitoring step, selectively assigning (318) an intent indicator (414) to the participants. The intent indicator can provide an indication as to whether a participant intends to attend the event. The monitoring step can include monitoring (316) target units (112) of the participants. The method can also include the step of creating (512) an attendance profile (610) for the participants based on a history of a participant's participation in previous events. The attendance profile can provide an indication as to the likelihood that a participant will attend the event and will attend the event on time.

### BACKGROUND OF THE INVENTION

1. Field of the Invention

This invention relates in general to methods and systems for organizing events and more particularly to methods and systems for tracking participation in such events.

2. Description of the Related Art

Almost all employees participate in meetings to advance work objectives. With the busy schedules that many workers maintain, it can be daunting when organizing such events. Even when a meeting time is agreed upon, many of the participants arrive late or do not even bother to attend at all. While some individuals may call ahead to notify the other persons attending the meeting that he or she may be running late but will arrive nonetheless, a number of intended participants do not exhibit such courtesy. As a result, a meeting organizer typically has no idea how long to delay a meeting to provide the persons who are late an opportunity to participate in the entire meeting.

### SUMMARY OF THE INVENTION

The present invention concerns a method for managing an event. The method can include the steps of assigning a number of participants to participate in an event, selectively monitoring the participants beginning at a predetermined time and based on the monitoring step, selectively assigning an intent indicator to the participants to provide an indication as to whether a participant intends to attend the event. The selectively monitoring step can include monitoring target units of the participants.

In one arrangement, the method can include creating an attendance profile for the participants. The attendance profile can be based on a history of a participant's participation in previous events in which the attendance profile can provide an indication as to the likelihood that a participant will attend the event and will attend the event on time. As an example, the creating an attendance profile step can include the steps of modifying a point total assigned to a participant based on whether the participant arrives at an event on time, assigning a first icon to the participant so long as the point total assigned to the participant does not reach a predetermined threshold and assigning a second icon to the participant when the point total assigned to the participant reaches the predetermined threshold.

For example, the first icon can represent that a participant has a history of attending events on time, and the second icon can represent that the participant has a history of not attending events on time. In addition, the creating an attendance profile step can include assigning a recent tracking indicator to the participants that reflects a participant's participation in previous events that is more recent and not necessarily the same as the attendance profile.

In one arrangement, the selectively assigning an intent indicator step can include the steps of assigning a first indicator to a participant who is on time at the event, assigning a second indicator and an update icon to a participant who is currently not present at the event but who is attempting to attend the event and assigning a third indicator and an update icon to a participant from whom no attempt response has been received. The update icon associated with the second indicator can be at least one of an icon that reflects that the participant is within a first predetermined range and an icon that reflects that the participant is in a second predetermined range.

The method can also include the steps of determining whether a target unit is within a predetermined range of a participant assigned to the event and assigning the third indicator and the update icon to the participant if the target unit is outside the predetermined range of the participant. In another arrangement, the method can include the steps of detecting that a participant who has been assigned an intent indicator has stopped for at least a predetermined amount of time and signaling at least one interfering target unit within a predetermined range of the participant that the participant is assigned to the event.

The present invention also concerns a system for managing events. The system can include a central monitoring unit and a monitoring network in which the central monitoring station can communicate with the monitoring network. The central monitoring unit can assign a number of participants with target units to participate in an event, and the monitoring network can selectively monitor the target units of the participants beginning at a predetermined time. The monitoring network can also provide to the central monitoring unit information relating to the monitoring that it performs. Based on the monitoring performed by the monitoring network, the central monitoring unit can selectively assign an intent indicator as to whether a participant intends to attend the event. The system can also include suitable software and circuitry for performing the processes described above.

The present invention also concerns a mobile communications unit. The mobile communications unit can include a transceiver, a location acquisition element in which the location acquisition element can determine a location of the mobile communications unit and a processor. The processor can be coupled to the transceiver and the location acquisition element. The processor can be programmed to receive from a central monitoring unit through a monitoring network an assignment to an event and to receive positional information from the location acquisition element. The processor can be further programmed to instruct the transceiver to broadcast to the monitoring network the positional information to enable the central monitoring unit to assign an intent indicator to a user of the mobile communications unit. The intent indicator can provide an indication as to whether the user intends to attend the event.

In one arrangement, the mobile communications unit can include a user detection component coupled to the processor. The user detection component can determine whether the mobile communications unit is within a predetermined range of the user. In addition, the mobile communications unit can further include suitable software and circuitry for performing one or more of the processes described above.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates a system for managing events in accordance with an embodiment of the inventive arrangements;

FIG. 2 illustrates a target unit that can be used in the system of FIG. 1 in accordance with an embodiment of the inventive arrangements;

FIG. 3 illustrates a method of managing events in accordance with an embodiment of the inventive arrangements;

FIG. 4 illustrates an example of an indicator display in accordance with an embodiment of the inventive arrangements;

FIG. 5 illustrates another method of managing events in accordance with an embodiment of the inventive arrangements; and

FIG. 6 illustrates another example of an indicator display in accordance with an embodiment of the inventive arrangements.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

The invention concerns a method and system for managing an event. In one arrangement, the method can include the steps of assigning a number of participants to participate in an event, selectively monitoring the participants beginning at a predetermined time and based on the monitoring step, selectively assigning an intent indicator to the participants. The intent indicator can provide an indication as to whether a participant intends to attend the event. As an example, the selectively monitoring step can include monitoring target units of the participants. In another arrangement, the method can also include the step of creating an attendance profile for the participants based on a history of a participant's participation in previous events. The attendance profile can provide an indication as to the likelihood that a participant will attend the event and will attend the event on time.

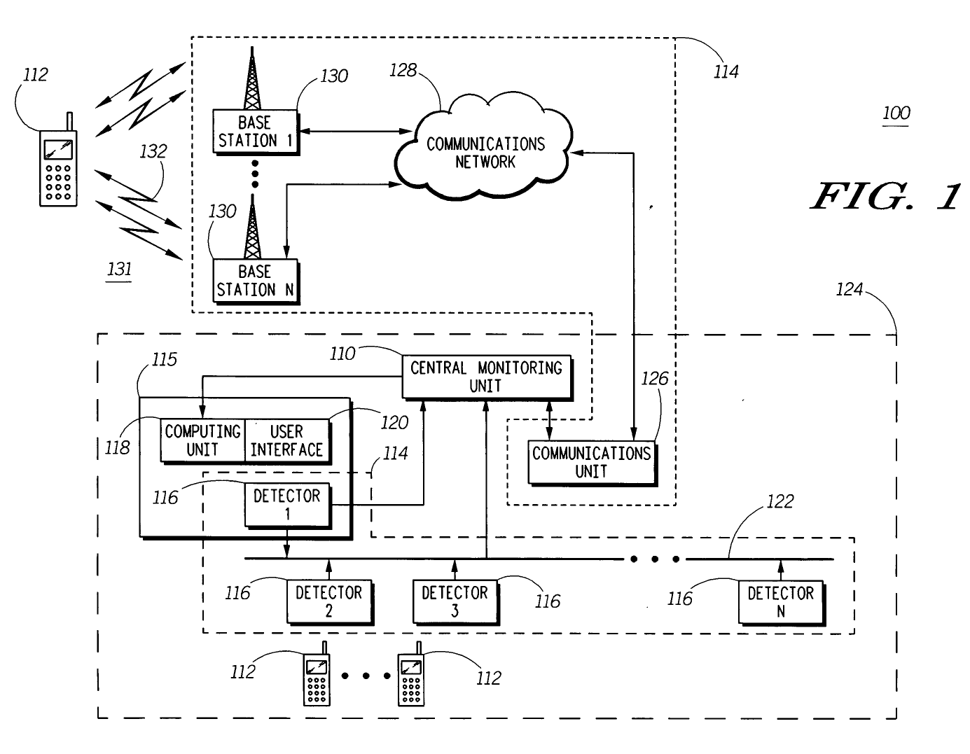

Referring to FIG. 1, a system 100 for managing an event is shown. The system 100 can include a central monitoring unit 110, which can monitor any suitable number of target units 112. As an example, the target units 112 can be portable electronic devices, such as a mobile communications units, assigned to or owned by a user who has been assigned to participate in an event. The system 100 can also have one or more monitoring networks 114, which can be communicatively coupled to the central monitoring unit 110, and an event location 115, which can be any physical location where an event is scheduled to take place. As an example, the event location 115 can be a conference room or an office, which can hold any number of participants. A computing unit 118 having a user interface 120 can be located in the event location 115 or some other suitable place.

In one arrangement, the monitoring network 114 can include any number of detectors 116 for detecting the target units 112. The detectors 116 can be any component that is able to detect the presence of the target units 112 and to notify the central monitoring unit 110 of such a detection. For example, the detectors 116 can include radio-frequency (RF) circuitry for detecting the target units 112 by receiving an RF signal from the target units 112 and for wirelessly notifying the central monitoring unit 110 when a target unit 112 is detected. As another example and as shown in FIG. 1, the detectors 116 can be coupled to a bus 122, which can also be coupled to the central monitoring unit 110. Here, the detectors 116 can receive RF signals from the target units 112 and signal the central monitoring unit 110 through the bus 122 when the detectors 116 receive the signals.

It must also be noted that, in either arrangement, the detectors 116 may communicate with one another. Such a configuration may permit one detector 116 to signal another detector 116 when it senses the target unit 112, and this process may be repeated until one of the detectors 116 signals the central monitoring unit 110. This arrangement can reduce the amount of power required by the detectors 116. One particular example of a suitable monitoring network 114 is a Neurfon network, which was developed by Motorola, Inc. of Schaumburg, Ill., although it is understood that the invention is in no way limited as such.

These detectors 116 can be positioned in accordance with various arrangements, and combined, they can form a predetermined range 124. Specifically, the operating ranges of the detectors 116, or the range at which they can detect the target units 112, can be the predetermined range 124. The predetermined range 124 can be designed to coincide with the boundaries of a building or some other location. As another example, at least one of the detectors 116 can be positioned in the event location 115.

The monitoring network 114 may also be designed to monitor target units 112 outside the predetermined range 124. For example, the system 100 can include a communications unit 126, which can permit the central monitoring unit 110 to communicate with a communications network 128. The communications unit 126 can communicate with the communications network 128 over a hard-wired connection or through a wireless link. The communications network 128 can be communicatively coupled to any number of base stations 130, which can communicate with the target units 112 over wireless communications links 132, as is known in the art.

In one arrangement, the central monitoring unit 110 can signal the target units 112 through the communications unit 126, the communications network 128 and the base stations 130. In response the target units 112 can provide to the central monitoring unit 110 information that relates to the location of the target units 112. The area outside the predetermined range 124 but within the range of the communications network 128 and/or the base stations 130 can be referred to as a second predetermined range 131.

As an example, the communications network 128 can be the Public Switched Telephone Network (PSTN) or the Internet, although any other suitable network is within contemplation of the inventive arrangements. In addition, the communications unit 126 can be a switching circuit, a transceiver or a modem or any other suitable interface between the central monitoring unit 110 and the communications network 128.

As such, the monitoring network 114 can be a short-range monitoring network 114 when the detectors 116 are used to track the target units 112. In addition, the monitoring network 114 may be considered a long-range monitoring network 114 when the central monitoring unit 110 monitors the location of the target units 112 through the communications unit 126, the communications network 128 and the base stations 130. It is understood, however, that this configuration is merely one example of how the central monitoring unit 110 can track the target units 112, as other suitable systems may be employed.

As it tracks the target units 112, the central monitoring unit 110 can provide to the computing unit 118 information relating to the target units 112. For example, the central monitoring unit 110 can provide an indication as to whether a user of a target unit 112 is intending to attend an event. The central monitoring unit 110 can also track an event participant's history of attending events and can forward this data to the computing unit 118. The computing unit 118 can then provide the information it receives from the central monitoring unit 110 in a user-recognizable form at the user interface 120. Examples of this process will be presented below.

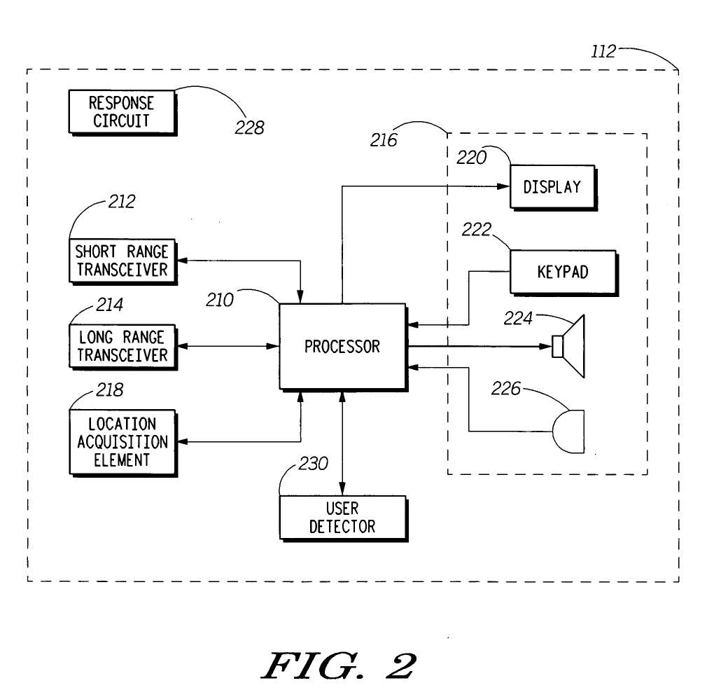

Referring to FIG. 2, an example of a target unit 112 is shown. As noted earlier, the target unit 112 may be a mobile communications unit, although the invention is not so limited. In one arrangement, the target unit 112 can include a processor 210, a short range transceiver 212, a long range transceiver 214 and a user interface section 216. The target unit 112 may also include a location acquisition element 218, which can be any suitable component that can enable the target unit 112 to determine its physical location. As an example but without limitation, the location acquisition element 218 can be a global positioning system (GPS) receiver. The short range transceiver 212, the long range transceiver 214, the user interface section 216 and the location acquisition element 218 can all be coupled to the processor 210.

In another arrangement, the user interface section 216 can include a display 220, a keypad 222, a speaker 224 and a microphone 226. A user of the target unit 112 can input data or voice through the display 220, the keypad 222 or the microphone 226.

The short range transceiver 212 can transmit to and receive signals from any corresponding short-range transceiver, such as a transceiver that operates on Bluetooth or any Wireless Fidelity (Wi-Fi) signal. As an example, the processor 210 can instruct the short range transceiver 212 to periodically transmit signals to the detectors 116 of the monitoring network 114. The long-range transceiver 214 can, for example, communicate with the base stations 130 over the wireless communications links 132 (see FIG. 1).

The target unit 112 may also include a response circuit 228, which may or may not be coupled to the processor 210. This response circuit 228 can be activated when the target unit 112 comes within the range of an activating field, such as a magnetic field. As is known in the art, once activated, the response circuit 228 may send a signal to the component that is generating the activating field. As an example, one or more of the detectors 116 may generate such an activating field. The signal from the response circuit 228 may include information that identifies the target unit 112 and/or the user of the target unit 112.

In another arrangement, the target unit 112 may include a user detector 230, which can be coupled to the processor 210. The user detector 230 can be any component that is capable of detecting that the target unit is located within a certain distance, i.e., within a predetermined range, of a human. Those of skill in the art will appreciate that there are numerous ways for the user detector 230 to determine that it is within a predetermined range of a user. For example, the user detector 230 can measure different capicitances that may occur when a user is holding the target unit 112. As another example, the user detector 230 can monitor the tuning of an antenna (not shown) of the target unit 112. When the antenna is detuned, this can be a suitable indication that the target unit 112 is within the predetermined range of the user.

It is understood that the invention is not limited to this particular target unit 112. Also, those of skill in the art will appreciate that the target unit 112 may contain other components that, while not necessary to describe here, permit the target unit 112 to perform other well-known functions or procedures.

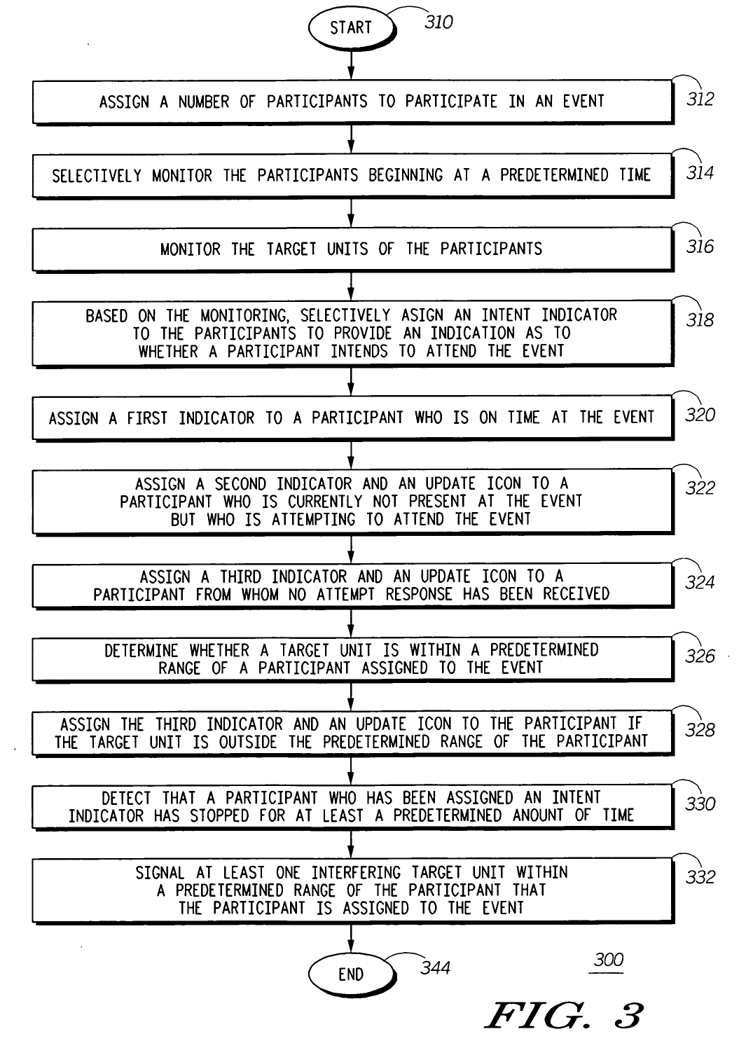

Referring to FIG. 3, a method 300 for managing an event is shown. Reference will be made to FIGS. 1 and 2 when describing the steps of the method 300. It is understood, however, that the method 300 can be implemented into any other suitable system or unit. Moreover, the invention is not limited to the order in which the steps are listed in the method 300. In addition, the method 300 can contain a greater or a fewer number of steps than those shown in FIG. 3.

At step 310, the method can begin. At step 312, a number of participants can be assigned to participate in an event. At step 314, beginning at a predetermined time, the participants can be selectively monitored. As an example, at step 316, the participants can be selectively monitored by monitoring target units of the participants.

For example, referring to FIGS. 1 and 2, a user may wish to schedule an event, such as a meeting. The event may be scheduled to be held at an event location 115 or some other predetermined area. The user can assign one or more participants to attend the event, and any number of the participants can be assigned to attend the event at the event location 115. Some of the participants may be scheduled to attend the event through electronic means, such as by calling into a conference telephone line or by accessing an Internet connection. Although not physically present at the event location 115, these participants may nonetheless participate in the event through suitable voice and video connections, as is known in the art.

To schedule the event, a user may assign participants to the event by selecting them from any suitable means. For example, the user can select participants from a database stored in the computing unit 118 or some other computing device and assign them to attend the event. In one arrangement, at least a portion of the participants can have a target unit 112, such as a mobile communications unit. Information concerning these target units 112, such as what type of device they are, contact data (e.g., telephone or dispatch numbers) and who owns the target units 112, can be registered with the central monitoring unit 110. This process can enable the central monitoring unit 110 to identify the target units 112 and the participants who own or use the target units 112.

Beginning at a predetermined time, the central monitoring unit 110 can monitor the participants scheduled to attend the event. As an example, the central monitoring unit 110 can monitor the target units 112 of the participants beginning at a predetermined time before the event is scheduled to begin. In particular, the processor 210 of the target unit 112 can instruct the short range transceiver 212 to transmit, for example, an identifying signal at predetermined intervals. One or more of the detectors 116 of the monitoring network 114 can detect this transmission and can signal the central monitoring unit 110 or one or more other detectors 116 to signal the central monitoring unit 110. The identification of the target unit 112 can occur at the detectors 116, or the central monitoring unit 110 can identify the target unit 112. Because the detectors 116 may be positioned at various locations, the central monitoring unit 110 can determine whether the target unit 112 is moving and if so, the general direction of the movement.

If the central monitoring unit 110 determines that the detectors 116 have not detected a particular target unit 112 whose owner is assigned to participate in the event, the central monitoring unit 110 can signal the communications unit 126. This target unit 112 may be outside the predetermined range 124 and in the second predetermined range 131, for example. In response, the communications unit 126 can signal the communications network 128. The communications network 128, in accordance with well-known principles, can determine which of the base stations 130 is currently serving the target unit 112 in question. The base station 130, at the behest of the communications network 128, can determine the location of the target unit 112. As an example, the base station 130 can request positional information from the target unit 112 over a control channel, for example, and the target unit 112 can provide over the channel such data from its location acquisition element 218.

Of course, those of skill in the art will appreciate that other methods can be used to determine the location of the target unit 112 outside the predetermined range, such as any suitable triangulation technique. Once determined, the location of the target unit 112 outside the predetermined range 124 can be periodically updated in accordance with the discussion above.

There are other ways that the target units 112 can be monitored. For example, the communications unit 126 can be configured to wirelessly communicate with the target units 112 directly. The target units 112 can communicate with the communications unit 126 through the short range transceiver 212 or the long range transceiver 214. As such, the central monitoring unit 110 can signal the communications unit 126 to transmit a request to the target units 112. This request can seek information from a participant in control of a target unit 112, such as whether the participant intends to attend the event as scheduled. The intended participant can respond to the request by entering information through the user interface section 216. The target unit 112 can then transmit this information back to the communication unit 126, which can forward the response to the central monitoring unit 110.

A similar process can be performed using the communications network 128 and the base stations 130. That is, the central monitoring unit 110 can instruct the communications unit 126 to transmit a message to a target unit 112 through the communications network 128 and the base stations 130. The message can request whether a user of the target unit 112 intends to attend the event as scheduled. The user may send a response back to the central monitoring unit 110 through the base station 130, the communications network 128 and the communications unit 126.

In another arrangement, the detectors 116 may include circuitry for generating an activating field, such as a magnetic field, which can activate the response circuit 228 in the target unit 112 when the target unit 112 comes within the range of the activating field. The response circuit 228 can then transmit a signal to the detector 116, which can signal the central monitoring unit 110 or another detector 116, as described above. It must be noted, however, that the invention is not limited to the examples above, as there may be other ways to monitor the participants of the event in accordance with the inventive arrangements.

Referring back to the method 300, at step 318, based on the monitoring step, an intent indicator can be selectively assigned to the participants to provide an indication as to whether a participant intends to attend the event. At step 320, a first indicator can be assigned to a participant who is on time at the event. At step 322, a second indicator and an update icon can be assigned to a participant who is currently not present at the event but who is attempting to attend the event. A third indicator and an update icon can be assigned to a participant from whom no attempt response has been received, as shown at step 324.

For example, referring again to FIGS. 1 and 2, the central monitoring unit 110 can determine whether the participant is intending or attempting to attend the event. In particular, the detector 116 in the event location 115 can detect the presence of a target unit 112 in or near the event location 115, which can be an indication that the participant who owns that target unit 112 will attend the meeting. As another example, a participant may be moving towards or away from the event location 115, and the central monitoring unit 110 can determine this by receiving the signals from the different detectors 116 that are detecting the movement. The central monitoring unit 110 may also determine that the participant is stationary.

This same principle can apply to target units 112 that are in the second predetermined range 131. For instance, the central monitoring unit 110 can periodically request and receive positional information relating to these target units 112. The central monitoring unit 110 can then determine whether the target unit 112 is moving towards or away from the event location 115 or whether the participant is stationary. The central monitoring unit 110 can also process any messages that it receives from the target units 112, whether the target units 112 are within or outside the predetermined range 124. These messages may be responses that the participants have provided through their target units 112 that give an indication as to whether they intend to attend the event.

It is important to note that the event location 115 may not be the only location where a participant is scheduled to be at a particular time. For example, a participant may be assigned to attend a meeting, but the participant may be located in another state. The participant may attend the event by calling on a conference call or through video conferencing. In this case, the participant may be assigned to be at a location other than the event location 115. The central monitoring unit 110, in accordance with the above discussion, can track this participant with respect to the location that is different from the event location 115.

The central monitoring unit 110 can then assign indicators to the participants based on its monitoring of the participants. The central monitoring unit 110 can then signal the computing unit 118 (or some other suitable unit) with these indicators, and they can be displayed or broadcast, for example, to a user through the user interface 120. The computing unit 118 and the user interface 120 may be in the event location 115 or some other suitable location.

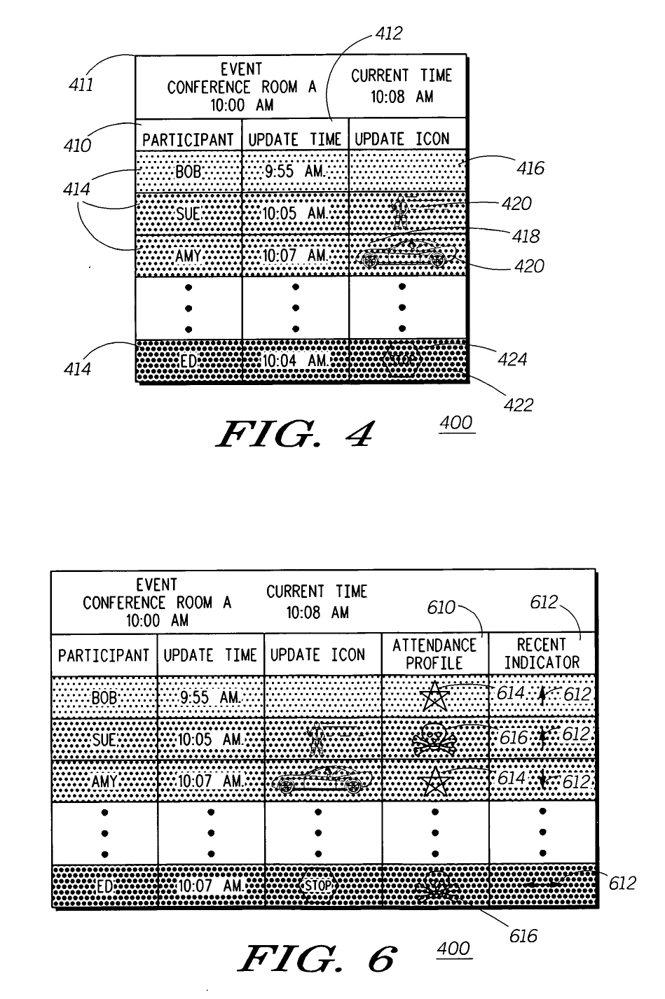

Referring to FIG. 4, an example of an indicator display 400 is shown. The indicator display 400 can be provided to a user through, for example, the user interface 120 of FIG. 1. In one arrangement, the display 400 can include an event information block 411, one or more participants 410 and corresponding update times 412. The event information block 411 can provide details about the event. In this example, an event can be scheduled in conference room A at 10:00 a.m. The participants 410 can be those individuals assigned to the event. Different types of indicators can be assigned to the participants 410 and the last time that the indicator was updated can be reflected by the update times 412.

For example, one participant, whose name may be Bob, may be in conference room A or another appropriate location at 9:55 a.m. The central monitoring unit 110 can determine this condition in accordance with the description above and can assign an intent indicator 414 to Bob. As an example, the intent indicator 414 can be a first indicator 416, which can be any user-perceivable feature that provides an indication that the participant is on time and present. In this case, the first indicator 416 can be a colored background over which the participant's name (and possibly other information) may be superimposed. Although not shown here, the color may be green, for example. The update time 412 can reflect that the last update was provided at 9:55 a.m.

Consider another example: the central monitoring unit 110 has determined that a participant named Sue is in the predetermined range 124 and is moving towards the event location 115 (conference room A) or other appropriate place. The current time may be 10:08 a.m., which indicates that Sue is late for the event. As such, the central monitoring unit 110 can assign a second indicator 418 to serve as the intent indicator 414. This second indicator 418 may also be a colored background over which Sue's name (and possibly other information) is superimposed; however, the color can be different from that of the background for Bob. For example, this color can be yellow. The update time 412 can be 10:05, which reflects the last time that Sue's status was updated.

Another part of the intent indicator 414 in this example can be an update icon 420. In this example, the update icon 420 that can be assigned to Sue can be a figure that represents an individual hurriedly moving. Other suitable figures or symbols can serve as the update icon 420. The second indicator 418 in combination with the update icon 420 can indicate that Sue is late but that she is in the predetermined range 124 and still intends to attend the event. It is understood that Sue may also provide this information directly into her target unit 112 in response to a message from the central monitoring unit 110. For instance, Sue can select from a menu on the target unit 112 that she is in the predetermined range 124, that she will be late and that she is on her way to the event room 115.

As another example, the central monitoring unit 110 may determine that another participant named Amy is in the second predetermined range 131 but is moving towards the event location 115 (conference room A) or other appropriate place. Amy's update time 412 may be 10:07 a.m. Similar to the intent indicator 414 assigned to Sue, a colored background, such as a yellow background, can be the second indicator 418. The update icon 420, however, can be, for example, a symbol that represents a person driving a vehicle. In this example, the second indicator 418 and the update icon 420 can reflect that Amy is late for the meeting and is outside the predetermined range 124 but that she still intends to attend the event. It is understood, however, that the second indicator 418 and the update icon 420 are not limited to these examples and they may be any user-perceivable feature that respectively provides an indication that the participant is late but is attempting to arrive at the event and whether the participant is within or outside the predetermined range 124.

In yet another example, the central monitoring unit 110 can determine that no attempt response has been received from a participant named Ed. An attempt response can be any response that signals that the participant in question is attempting to attend the event. As an example, Ed may be stationary or his target unit 112 may be off. As another example, Ed may be moving away from the event location 115 or other appropriate place. Also, the participant Ed may respond to a request from the central monitoring unit 110 by entering information into his target unit 112 that informs the central monitoring unit 110 that Ed will not attend the meeting. Although an active step may be performed, such as in the example of Ed sending a response notifying the central monitoring unit 110 that he will not attend, the central monitoring unit 110 can still designate it as a no attempt response.

In either arrangement, the central monitoring unit 110 can assign a third indicator 422, which can be the intent indicator 414. As an example and similar to the first indicator 416 and the second indicator 418, the third indicator 422 can be a colored background over which Ed's name (and possibly other information) can be superimposed. The color here can be red, for example. The central monitoring unit 110 can also assign an update icon 424, which can be part of the intent indicator 414. For example and as shown in FIG. 4, a stop sign symbol can indicate that the participant is currently stopped or that his target unit 112 is turned off, for example. Numerous symbols can be used as the update icon 424 to reflect some particular status that is causing the no attempt response condition. In this example, Ed's update time 412 may be 10:04 a.m. It is understood that the third indicator 422 and the update icon 424 are not limited to these examples and they may be any user-perceivable feature that respectively provides an indication that the participant is late to the event and that no attempt response has been received.

The status of any of the participants can be updated at any time. This update can occur at predetermined intervals, as dictated by the central monitoring unit 110 or some other component. In another arrangement, an update request for one or more participants can be selected at, for example, the computing unit 118. When an update is performed, the central monitoring unit 110 can seek an update on the location and/or direction of the relevant target units 112 in accordance with the description above. During the updates, the intent indicators 414 of the participants may change. For example, a stationary participant may begin to move towards the event location 115, and the participant's intent indicator 414 can be modified to reflect this change.

Referring back to method 300 of FIG. 3, at step 326, it can be determined whether a target unit is within a predetermined range of a participant assigned to the event. In addition, at step 328, the third indicator and an update icon can be assigned to the participant if that target unit is outside the predetermined range of the participant.

For example, referring once again to FIGS. 1 and 2, when the central monitoring unit 110 is monitoring the target units 112, the central monitoring unit 110 can determine whether the target unit 112 is within a predetermined range of a user. Specifically, the processor 210 of the target unit 112 can instruct the user detector 230 to determine whether the target unit 112 is within the predetermined range. The user detector 230 can do so and can signal the processor 210, which can in turn signal the short range transceiver 212 or the long range transceiver 214 to send this status to the appropriate monitoring network 114.

If the central monitoring unit 110 determines that the target unit 112 is outside the predetermined rang of the user, i.e., the target unit 112 may not be near the user, the central monitoring unit 110 can assign a third indicator 422 and an update icon 424 to the user or participant, as described in relation to FIG. 4. Conversely, the central monitoring unit 110 can continue with the process of assigning intent indicators 414 (see FIG. 4) if it determines that the target unit 112 is within the predetermined range of the user or participant.

Referring back to the method 300, at step 330, a situation where a participant who has been assigned an intent indicator and who has been stopped for at least a predetermined amount of time can be detected. At step 332, at least one interfering target unit within a predetermined range of the participant can be signaled that the participant is assigned to the event. At step 334, the method 300 can end.

For example, referring again to FIGS. 1, 2 and 4, the central monitoring unit 110, through the monitoring network 114, can determine that a participant having a target unit 112 has stopped. This participant may have already been assigned an intent indicator 414. After a predetermined amount of time, the central monitoring unit 110 can determine whether any potentially interfering target units 112 are within a predetermined range of the participant with the target unit 112 being monitored. As an example, the predetermined range can be a radius of several feet. These potentially interfering target units 112 may belong to one or more individuals who have stopped the participant and may be preventing the participant from attending the event. The central monitoring unit 110 can locate the potentially interfering target units 112 through the monitoring networks 114 or through any other well-known procedure.

In response to the stoppage, the central monitoring unit 110 can generate a message that indicates that the participant is on his or her way to an event and cannot be stopped. The central monitoring unit 110 can then instruct the communications unit 126 or some other suitable component to transmit the message to the potentially interfering target units 112. Once received, the message can be displayed or broadcast to the user of the potentially interfering target unit 112.

Although several examples have been presented for monitoring participants assigned to an event and selectively assigning intent indicators to these participants, it must be noted that the invention is not so limited. There may be many other ways within the scope of the invention to perform this concept. Based on the monitoring of the participants, an event organizer can make an informed decision when considering whether to delay the start of an event or to simply cancel the event, for example.

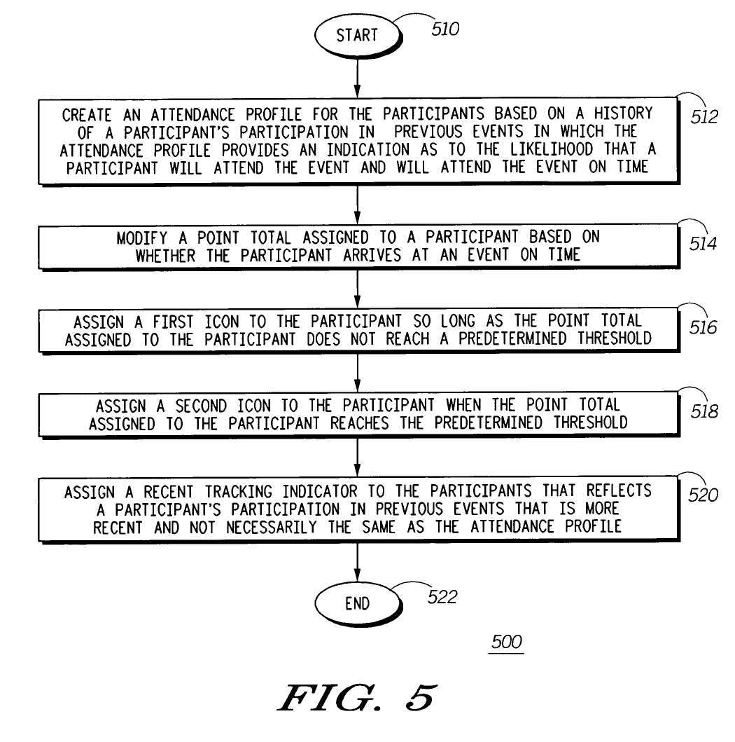

Referring to FIG. 5, a method 500 that presents another example of assigning intent indicators is shown. Similar to the method 300 of FIG. 3, reference will be made to FIGS. 1 and 2 when describing the steps of the method 500. It is understood, however, that the method 500 can be implemented into any other suitable system or unit. Moreover, the invention is not limited to the order in which the steps are listed in the method 500. In addition, the method 500 can contain a greater or a fewer number of steps than those shown in FIG. 5.

At step 510, the method 500 can begin. At step 512, an attendance profile for the participants can be created. The attendance profile can be based on a history of a participant's participation in previous events, and the attendance profile can provide an indication as to the likelihood that a participant will attend the event and will attend the event on time. As an example, at step 514, a point total assigned to a participant can be modified based on whether the participant arrives at an event on time. As a more specific example, a first icon can be assigned to the participant so long as the point total assigned to the participant does not reach a predetermined threshold, as shown at step 516. As another example, a second icon can be assigned to the participant when the point total assigned to the participant reaches the predetermined threshold, as shown at step 518.

At step 520, a recent tracking indicator can be assigned to the participants. The recent tracking indicator can reflect a participant's participation in previous events that is more recent and not necessarily the same as the attendance profile. The method 500 can end at step 522.

For example, referring to FIG. 6, another example of an indicator display 400 is shown. This indicator display 400 can also be provided to a user through, for example, the user interface 120 of FIG. 1. The indicator display 400 of FIG. 6 can incorporate one or more of the features that are described in relation to the indicator display of FIG. 4. In addition, the indicator display 400 of FIG. 6 can include an attendance profile 610 and a recent tracking indicator 612 for the participants 410. The attendance profile 610 can be based on the participant's participation in previous events, as monitored by the central monitoring unit 110.

As an example, a point total can be assigned to one or more participants. If a participant arrives on time to an event, the central monitoring unit 110 can modify the point total of that participant by adding a number of points to the point total. The term on time can mean arriving before or at the scheduled time or even arriving a predetermined amount of time after the scheduled time. As another example, if a participant arrives late to an event, the central monitoring unit 110 can modify the point total of that participant by deducting a number of points from the point total.

The central monitoring unit 110 can assign a first icon 614 to a participant so long as the point total for the participant does not reach a predetermined threshold. For example, so long as the point total for a participant does not fall below a predetermined number, the central monitoring unit 110 can assign a first icon 614 to the participant. In FIG. 6, it can be seen that the participants with the names Bob and Amy can have a first icon 614, which can be a star, for example. The star can reflect that Bob and Amy generally attend events and arrive to the events on time.

Conversely, if the point total for a participant falls below the predetermined number, the central monitoring unit 110 can assign a second icon 616 to the participant. For example, the participants with the names Sue and Ed can have a second icon 616, which can be a skull and cross bones symbol. The skull and cross bones symbol can indicate that Sue and Ed have a history of either not showing up for events or showing up late for events. Of course, any user-perceivable feature that gives an indication of the attendance history of a participant can serve as a first icon 614 or a second icon 616.

There may be certain instances where a participant has been assigned with a first icon 614 or a second icon 616 but the recent participation history of the participant may not coincide with the assigned first icon 614 or second icon 616. As a result, the central monitoring unit 110 can assign a recent tracking indicator 612 to the participants based on recent participation.

For example, consider the participant with the name Bob. Bob has been assigned with a first icon 614, which reflects that Bob arrives to events on time. The central monitoring unit 110, focusing on the most recent events in which Bob has participated, can assign a recent tracking indicator 612 in the form of an arrow pointing up, which can indicate that Bob continues to arrive on time to events. The most recent events can relate to, for example, a participant's participation in the last three or four events or the events for the most recent month or other suitable time period.

As another example, the participant with the name Sue can be assigned with a second icon 616, which may indicate that Sue shows up late for events or does not show up at all. Nonetheless, the central monitoring unit 110 may detect that Sue has arrived on time for the previous three events to which she was assigned. In response, the central monitoring unit 110 can assign a recent tracking indicator 612 in the form of an arrow pointing up, which can reflect Sue's improved performance.

The central monitoring unit 110 can also assign recent tracking indicators 612 in the form of arrows pointing down or horizontal arrows. The pointing down arrows can indicate that the most recent participation of a participant has been poor, i.e., late or does not show up. The horizontal arrows can reflect that the most recent participation has been equivalent to the rating designated by the first icon 614 or second icon 616. For example, one can discern that the participant named Amy has recently sullied her first icon 614 rating and that the participant named Ed has shown no change in his second icon 616 rating.

This monitoring process can help an event organizer make an informed decision concerning how best to proceed with an event. It must be noted that the invention is in no way limited to the examples described above, however, as there may be other ways to create attendance profiles that are within the scope of the invention. Moreover, any other suitable method can be used to assign recent tracking indicators.

Where applicable, the present invention can be realized in hardware, software or a combination of hardware and software. Any kind of computer system or other apparatus adapted for carrying out the methods described herein are suitable. A typical combination of hardware and software can be a mobile communication device with a computer program that, when being loaded and executed, can control the mobile communication device such that it carries out the methods described herein. The present invention can also be embedded in a computer program product (including a machine readable storage having a plurality of code sections), which comprises all the features enabling the implementation of the methods described herein and which when loaded in a computer system, is able to carry out these methods.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for managing an event, comprising:
assigning a number of participants to participate in an event;
selectively monitoring the participants beginning at a predetermined time; and
based on the monitoring step, selectively assigning an intent indicator to the participants to provide an indication as to whether a participant intends to attend the event.

2. The method according to claim 1, wherein the selectively monitoring step comprises monitoring target units of the participants.

3. The method according to claim 1, further comprising:
creating an attendance profile for the participants based on a history of a participant's participation in previous events, wherein the attendance profile provides an indication as to the likelihood that a participant will attend the event and will attend the event on time.

4. The method according to claim 3, wherein the creating an attendance profile step comprises:
modifying a point total assigned to a participant based on whether the participant arrives at an event on time;
assigning a first icon to the participant so long as the point total assigned to the participant does not reach a predetermined threshold; and
assigning a second icon to the participant when the point total assigned to the participant reaches the predetermined threshold.

5. The method according to claim 4, wherein the first icon represents that a participant has a history of attending events on time and the second icon represents that the participant has a history of not attending events on time.

6. The method according to claim 4, wherein the creating an attendance profile step comprises assigning a recent tracking indicator to the participants that reflects a participant's participation in previous events that is more recent and not necessarily the same as the attendance profile.

7. The method according to claim 1, wherein the selectively assigning an intent indicator step comprises:
assigning a first indicator to a participant who is on time at the event;
assigning a second indicator and an update icon to a participant who is currently not present at the event but who is attempting to attend the event; and
assigning a third indicator and an update icon to a participant from whom no attempt response has been received.

8. The method according to claim 7, wherein the update icon associated with the second indicator is at least one of an icon that reflects that the participant is within a first predetermined range and an icon that reflects that the participant is in a second predetermined range.

9. The method according to claim 7, further comprising:
determining whether a target unit is within a predetermined range of a participant assigned to the event; and
assigning the third indicator and the update icon to the participant if the target unit is outside the predetermined range of the participant.

10. The method according to claim 1, further comprising:
detecting that a participant who has been assigned an intent indicator has stopped for at least a predetermined amount of time; and
signaling at least one interfering target unit within a predetermined range of the participant that the participant is assigned to the event.

11. A system for managing events, comprising:
a central monitoring unit; and
a monitoring network, wherein the central monitoring unit communicates with the monitoring network;
wherein the central monitoring unit assigns a number of participants with target units to participate in an event;
wherein the monitoring network selectively monitors the target units of the participants beginning at a predetermined time and provides to the central monitoring unit information relating to the monitoring that it performs;
wherein based on the monitoring performed by the monitoring network, the central monitoring unit selectively assigns an intent indicator as to whether a participant intends to attend the event.

12. The system according to claim 11, further comprising a user interface, wherein the user interface provides to a user the participants and the intent indicator assigned to the participants.

13. The system according to claim 11, wherein the central monitoring unit creates an attendance profile for the participants based on a history of a participant's participation in previous events, wherein the attendance profile provides an indication as to the likelihood that a participant will attend the event and will attend the event on time.

14. The system according to claim 13, wherein to create the attendance profile, the central monitoring unit:
modifies a point total assigned to a participant based on whether the participant arrives at an event on time;
assigns a first icon to the participant so long as the point total assigned to the participant does not reach a predetermined threshold; and
assigns a second icon to the participant when the point total assigned to the participant reaches the predetermined threshold.

15. The system according to claim 14, wherein the central monitoring unit, to help create the attendance profile, assigns a recent tracking indicator to the participants that reflects a participant's participation in previous events that is more recent and not necessarily the same as the attendance profile.

16. The system according to claim 11, wherein to assign the intent indicator, the central monitoring unit:
assigns a first indicator to a participant who is on time at the event;
assigns a second indicator and an update icon to a participant who is currently not present at the event but who is attempting to attend the event; and
assigns a third indicator and an update icon to a participant from whom no attempt response has been received.

17. The system according to claim 16, wherein the central monitoring unit determines that a target unit is within a predetermined range of a participant assigned to the event and assigns the third indicator and the update icon to the participant if the target unit is outside the predetermined range of the participant.

18. The system according to claim 11, wherein the central monitoring unit, through the monitoring network, detects that a participant who has been assigned an intent indicator has stopped for at least a predetermined amount of time and signals at least one interfering target unit within a predetermined range of the participant that the participant is assigned to the event.

19. A mobile communications unit, comprising:
a transceiver;
a location acquisition element, wherein the location acquisition element determines a location of the mobile communications unit; and
a processor, wherein the processor is coupled to the transceiver and the location acquisition element;
wherein the processor is programmed to receive from a central monitoring unit through a monitoring network an assignment to an event and to receive positional information from the location acquisition element;
wherein the processor is further programmed to instruct the transceiver to broadcast to the monitoring network the positional information to enable the central monitoring unit to assign an intent indicator to a user of the mobile communications unit, wherein the intent indicator provides an indication as to whether the user intends to attend the event.

20. The mobile communications unit according to claim 19, further comprising a user detection component coupled to the processor, wherein the user detection component determines whether the mobile communications unit is within a predetermined range of the user.
